(19) United States
(12) Patent Application Publication
(10) Pub. No.: US 2012/0225176 A1
(43) Pub. Date: Sep. 6, 2012

(54) DEVICE FOR TIMING AND AUTOMATICALLY STEEPING TEA

(76) Inventor: Michael Vincent DiStefano, Irvine, CA (US)

(21) Appl. No.: 13/411,246

(22) Filed: Mar. 2, 2012

Related U.S. Application Data
(60) Provisional application No. 61/448,314, filed on Mar. 2, 2011.

(51) Int. Cl. A47J 31/20; A23F 3/16

(52) U.S. Cl. 426/435; 99/283

(57) ABSTRACT

Steeping loose leaf tea necessitates that one utilize some sort of filtration device. All current devices that seek to fulfill this requirement are either manual, such as empty tea bags and stainless steel mesh filters, or very expensive electronic automatic steepers. In addition to a filtration device one must use a timer to determine how long to steep the tea leaves. Ordinarily, when the timer goes off, one must remove the tea leaves and filter from the water; otherwise, the tea will over-steep and become bitter or over-caffeinated. Current timers do not stop the tea from steeping, but only signal that it is done, leaving the removal of the tea leaves up to the individual.

### RELATED APPLICATIONS

This application claims the full Paris Convention benefit of, and priority to, U.S. Provisional Patent Application Ser. No. 61/448,314 filed Mar. 2, 2011 by the instant inventor, the contents of which are incorporated herein by reference in its entirety, as if fully set forth herein.

### BACKGROUND OF THE INVENTIONS

### 1. Field of the Disclosures

The present invention relates to devices used for preparing beverages to be consumed. In particular, the present invention defines apparatus for timing and automatically steeping loose leaf tea. These devices allow for loose tea leaves to saturate in water, or other liquid, (in order to soften and extract the constituents), as well as embody a temperature control mechanism, inter alia, enabling users to create personal aliquots, group-consumables and related volumes of tea to drink, now and later.

With tea being the most consumed beverage in the world, after water, the need for convenience and quality in herbal infusion is paramount. This trend traces back to ancient times, and the parallel use of alcohol only urges more strongly for the novelty of the instant teachings, in contradistinction, as tea's overall impact on society is rarely framed in negative terms. In fact, tea is now being recognized as a source of powerful and healing antioxidants, tannins, and caffeine (which itself catalyzes, in part, normal glucose metabolism), making tea generation an important need in today's society. Surprisingly, challenges still exist in making tea for personal use.

The amount of tea to be used per amount of water differs from tea to tea and the length of steeping time also varies, depending on the type. For example, most green teas should be allowed to steep for about two minutes, although some types of tea require as much as ten minutes, and others as little as thirty seconds. Black and white teas take 4-5 minutes to steep while oolong takes about 3-4 minute. Therefore, a device that has an automatic timer for steeping tea is essential, yet not conventionally available conveniently, prior to the advent of the instant teachings. User dictated steeping time is a desideratum which remains longstanding in an automatic device.

The temperature at which tea is prepared can affect the quality of the tea. The water used for black tea is the only water that should be completely boiled at a temperature of about 200 degrees Fahrenheit. Oolong tea is typically brewed with water heated to a slightly lower temperature of 190 degrees Fahrenheit (almost boiling), and green and white teas are steeped in steaming water, or water with a temperature of about 170 degrees Fahrenheit. The need for better management and control of these issues goes without saying, and it is respectfully proposed, qualifies any subject-matter ameliorating the same as progress in science and the useful arts.

### SUMMARY OF THE INVENTIONS

Briefly stated, improved devices address filtration, temperature and timing issues for steeping loose leaf tea by providing integrated units comprised of a timer and a filter. The user sets the timer (based on the type and quality of the tea) and when the timer is done, each device automatically stops the tea from steeping, in order that it does not become over processed.

According to embodiments, there is provided a device which comprises an automatic tea timer and filter. It is designed to filter loose leaf tea leaves and time the appropriate duration for steeping. It is designed to fit inside of a standard sized tea-coffee mug and is also designed to withstand the heat of boiling water as well as temperature fluctuations from lower than room temperature to slightly above boiling. The automatic tea timer and filter 1 is a device roughly resembling an acorn, but roughly the size of a chicken egg.

According to embodiments, there is provided a multi-cup apparatus embedded in a system for brewing tea, which comprises, in combination, a cap assembly, including a hook/handle operative linked to a timing mechanism, a tube having trapped air, for housing a piston, operatively linked to the timing mechanism by a bridge mechanism, an ingress-egress means, likewise operatively linked to the timing mechanism, a glass container; and, a stainless steel mesh layer whereby, in use, the glass container houses loose leaf tea, which steeps in hot water for a duration of time pre-set by a user, that is meted-out by release of air pressure, as the piston moves from a first to a second position, rotating the bridge and ingress-egress means to allow for a finished product to be released.

According to embodiments, there is provided an improved device for timing and steeping tea, which comprises, in combination, a cap assembly, a main container, a timing mechanism, and a filter layer wherein the timing mechanism is in operative communication with the cap assembly, and whereby a user can observe rotation of the timing mechanism to determine when the tea has been steeped appropriately.

### BRIEF DESCRIPTION OF THE DRAWINGS

FIG. 1 shows a schematic embodiment of a Teadrop™ brand of device, in situ, according to the present invention;

FIG. 2 shows a schematic embodiment of the Teadrop™ brand of device, standing alone, according to the present invention;

FIG. 3 shows a partially exploded view of embodiments, according to the present invention;

FIG. 4 shows a detailed view of the cap assembly in partially exploded form, according to embodiments of the present invention;

FIG. 5 shows setting and operation of the timer embodiments, according to the present invention;

FIG. 6 shows detail schematics of a piston traveling within a sealed-air tube, according to teachings of the present invention;

FIG. 7 likewise illustrates operation of embodiments according to the teachings of the present invention; and

FIG. 8 shows internal mechanism details according to the teachings of the present invention.

### DETAILED DESCRIPTION OF THE DISCLOSURE

The present inventor has instantiated, in apparatus having the elegant aesthetics of an acorn, roughly the size of an egg, an automatic tea timer, useful for making single cups of tea, multiple cups of tea, and/or a transport and storage function.

The present inventor has discovered ways of making tea for individual servings, multi-cup offerings and Thermos® (brand of containers) types of delivery. Each features steeping and timing guidance, currently unavailable in simply elegant forms, particularly in “right-sized” form for travel and ready transport; for example, in the pocket or handbag of a user.

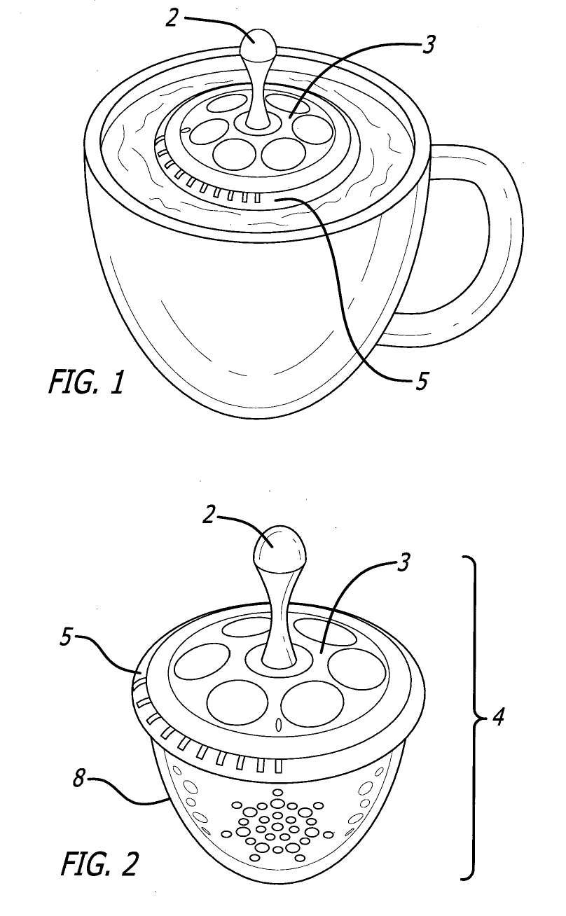

In referring to the figures, particularly FIG. 1 and FIG. 2 the Teadrop™ Teas brand of device 4 is comprised of two main parts, container for tea leaves 8, and main cap 3 with timer assembly/mechanism 5. Main cap 3 and timer assembly/mechanism 5 can be removed to insert tea leaves into glass container 8.

Teadrop™ brand of device is designed to fit snugly so that no water is able to leak out when closed. It is possible to make the aforementioned glass container portion out of a food-safe plastic; however, glass is preferred in terms of staining, durability, chemical safety, and heat resistance. The main caps and timer assembly/mechanism 5 are assembled out of stainless steel; however, a strong food safe plastic may also work.

Referring still to FIGS. 1, 2, and 3, cap 3 and timer assembly/mechanism 5 dispose timer mechanism 5 residing in an airtight compartment. A user rotates the main cap 3 to wind the timer 5. As known to artisans, the timer 4 rotates about the space between cap 3 and glass container 8, measuring units of time, as in any standard timing mechanism, thus further description is omitted at this time, as artisans realize the timer plate 10 is rotationally engaged by filter layer 12. Timer assembly/mechanism 5 is housed in an airtight compartment to ensure rotation can function to move other elements. As user rotates main cap 3 with handle/hook 2, outer hash marks align with desired time intervals.

Glass container 8 has at least two openings G; each may be fitted with a stainless steel mesh 12, or preferably are lined with durable filter material 12, such as polypropylene, likewise equipped with aligning aperatures. Durable filter materials could be used in place of stainless steel mesh such as, but not limited to, carbon nanotubes in silicone, or plastic mesh or grates.

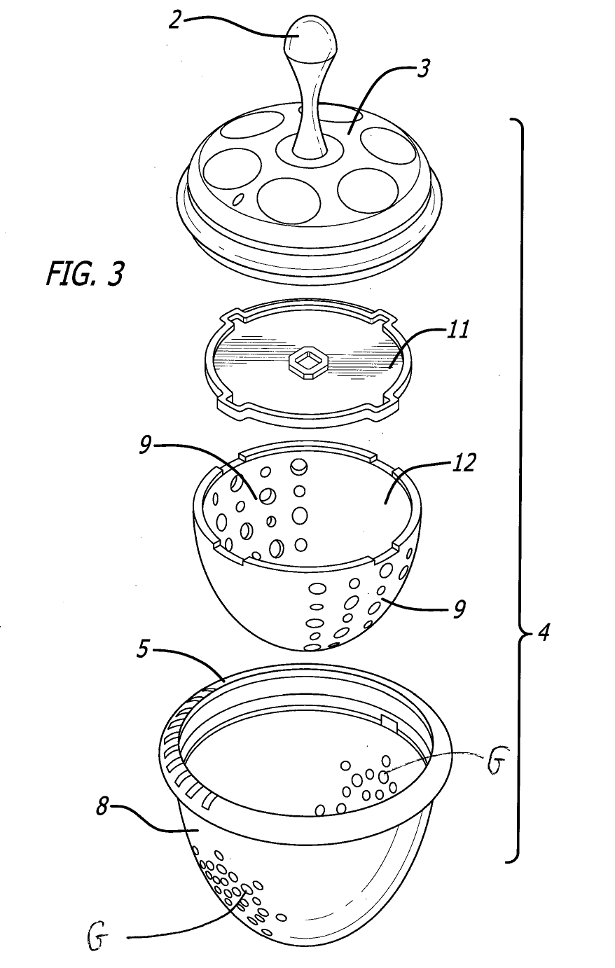

Referring still to FIG. 3, timer assembly/mechanism 5 is attached to central bridge 11. When the timer 5 has reached zero, it rotates central bridge 11. In operation, rotation of central bridge 11, which functions as a drive cap, aligns openings G with apertures 9 forming ports to seal the glass container by opening up the ports when the timer is up.

Referring still to FIG. 1 through FIG. 4, device 4 contains handle/hook 2 which is affixed to main cap 3 that allows one to safely remove the main cap 3 after being disposed in, at times, boiling water and subsequently hang the entire device in a convenient location for storage or display. A stand or carrying case is included with the invention (not shown) to make it more convenient for a user to store, transport, or display the invention. Also, timer marks are added for convenience on timer 5, whereby time increments of a minute to longer time intervals are marked.

As shown in the figures, main cap 3 and timer 4 assembly/mechanisms are preferably connected to each other permanently. Main cap 3 rotates within the timer mechanism 5 so it should preferably be attached at axis point 15 in the center of central bridge 15. The unit formed by the main cap 3 and timer mechanism may be referred to as the cap assembly 6.

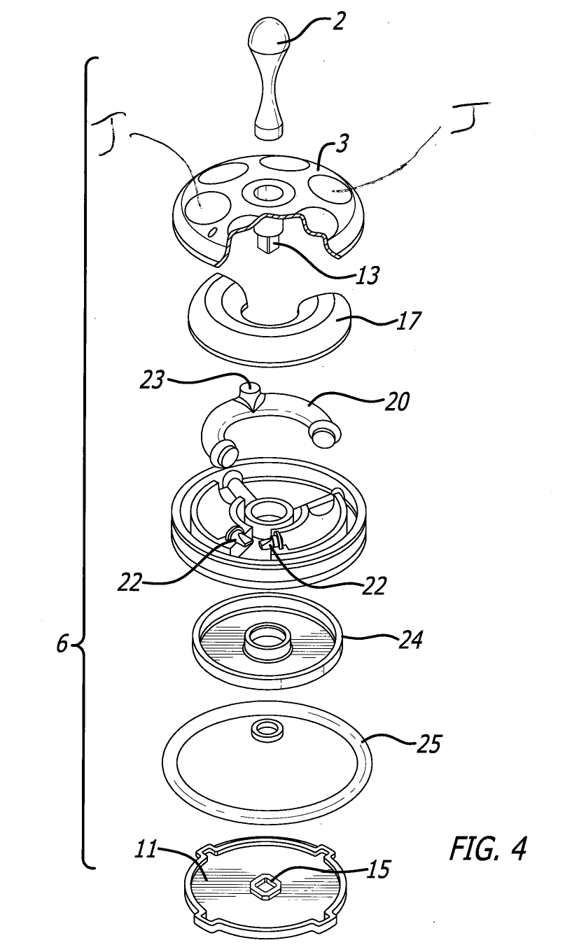

Referring specifically to FIG. 4, the cap assembly 6 sits snugly within the inner circumference of the top opening of the glass container 8 (FIGS. 1-3 and 5-7). It will need to be removed frequently for loading, unloading, and cleaning purposes. Therefore, friction between the outer wall of an inner extension of the cap assembly 6 and the inner wall of the glass container 8 holds the two together. Cap assembly 6 illustrates central bridge 11 and rod/axle 13 which rotates, as user rotates main cap 3, using finger cuffs J and/or handle/hook 2 to wind timer assembly/mechanism 5.

In use, the timer assembly/mechanism 5 is attached to central bridge 11 through rod 13. Rod 13 rotates like an axle when the timer is up, thus rotating central bridge 11. Rod 13 runs through axis point 15 at which the timer assembly/mechanism 5 and the main cap 3 are connected.

According to alternate embodiments, side caps (not shown) can be affixed to the central bridge 11 in a permanent fashion using food safe adhesives if the two components are separate. Alternatively, the entire unit will be cast from one mold and be a unique and distinct entity.

In alternate embodiments, stainless steel mesh is substituted for filter layer 12 and openings 9 will fit in the holes of the glass container 8. Ideally, they are completely flush with the inner surface so that the inner surface of the glass container is smooth. This is accomplished by having a dual pane glass container 8 with the stainless steel mesh between the two panes, in some embodiments. Alternatively, the mesh is affixed to the inner surface of the glass container 8 with a food safe adhesive.

As should be known to artisans, the invention provides a mechanism by which one is able to both time and filter loose tea leaves. It accomplishes this by having an integrated timer assembly/mechanism 5 and filter layer 12. The timer sits atop the filter layer 12 and rotates a mechanism so that the holes in the filter 9 close when the timer is up, with aperture 9 in glass container 8.

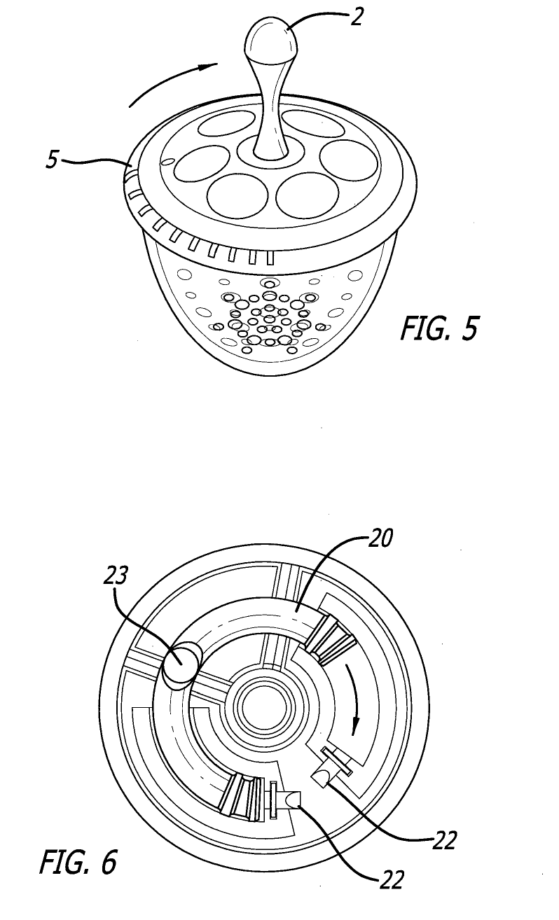

Referring now to FIG. 5, to use, one removes the top cap assembly 6 and fills the glass container 8 with loose tea leaves. The user then fastens main cap 3 back onto the top of glass container 8 and rotates timer 5 to a desired duration. When timer 5 has been set, device 4 is placed in a cup of hot water. Tube with trapped air stays afloat so that glass container 8 is always beneath the surface of the water and cap assembly 10 is always above the surface. The tea steeps until a timing cycle is completed.

Referring now to all of the Figures, when the pre-set time is up the timer mechanism 5 rotates central bridge 11, which closes the ports in glass container 8 by placing the side caps against the stainless steel mesh 12. At this time, timer mechanism 5 emits a sound to alert the user that their tea is done. After the caps close the stainless steel mesh 12 no more water is allowed into the device and the steeping process stops.

As shown in FIG. 4 and FIG. 5, one mechanism whereby the instant invention works includes piston 20 moving clockwise within tube with trapped air 17 with extension 23 linking same to timing mechanism 5, and bleeding the compressed air out through duck-bill valves 22. Likewise, rotational linkage elements/washers 24 and 25 maintain communication.

Those skilled in the art understand that alternately electronics or cogs and gears can accomplish the same function and are clearly contemplated to be within the scope of this application.

FIGS. 5 and 6 show the clockwise rotation of timer mechanism 5 relative to piston 20, extension 23 and duck-bill valves 22.

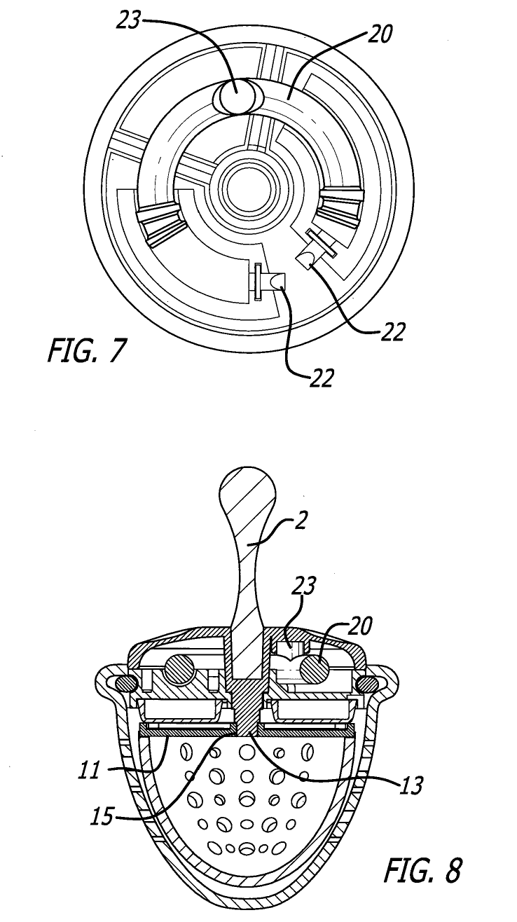

Referring now to FIG. 7 and FIG. 8, piston 20 is shown in a second position having had completed timing cycle. FIG. 8 shows an embodiment assembled, whereby the operative communications between elements of this embodiment are shown. Artisans readily understand these related mechanisms are within the scope of the invention as explained above and claimed below.

FIG. 8 likewise shows hook/handle 2, extension 23, piston 20, and the assembled relation to central plate 11, and axle 13 aligned in axis point 15.

When finished, the user may remove the device from the cup, remove the cap from the glass container and discard the used tea leaves. Finally, they can clean the device for the next use.

The present inventor has discovered a simple and elegant solution to steeping conventional teas and related desiderata.

It is possible that the number of ports in the main container be reduced to one at the bottom. The timer could, in this circumstance, push down a “plunger” to both expel water and close the port. It would work similar to a syringe. Any method by which a mechanical timer could close ports in a connected container is possible. Alternatively, a strong rubber “balloon” could be inflated within the device, thus expelling water and closing off any ports.

Another possibility could be for a weight to shift within the device so that the portion of the device submerged while steeping is above water when the timer is up so that the tea leaves no longer steep. It is also possible that a timer rotates an axel that raises the portion of the device holding the tea leaves above the surface of the water so that they no longer steep.

To use the invention, an individual must first remove the cap assembly from the main container. Then, the user places loose tea leaves into the main container. The user then reattaches the cap assembly to the main container by snugly inserting it into the main container. Next, the user rotates the main cap to set the timer. Once the timer is set the user places the device in a cup of hot water and waits until the timer is up. When the timer is up, the tea will automatically stop steeping because the ports in the main container would have closed. The timer will emit a sound to alert the user that their tea is done. When the user wishes to drink their tea, they may remove the device from the water. To empty the device, the user removes the cap assembly from the main container to expose the inside of the container. The user may then discard the used tea leaves as they see fit. The device may then be cleaned using standard kitchen cleaning utensils.

The invention may also be used to steep different substances other than tea. These substances may include, but are not limited to, herbal teas, flowers, any beverages to be steeped and/or coffee.

The device may also function as a simple kitchen timer.

According to embodiments, this invention provides an integrated unit with which to time, steep, and filter loose leaf tea automatically, rather than current solutions that separate the functions and require manual interaction.

Current devices require manual interaction in order to stop the tea leaves from steeping. This invention will automatically stop the leaves from steeping when an inbuilt timer is up.

Presently, users must have both a timer and a filtration device on hand to make loose leaf tea. The invention will combine the two so that a user needs only this device and tea leaves to make tea.

Devices to exist to steep tea automatically; however, they are large and require electrical outlets. This invention is approximately the size of a chicken's egg and is thus easy to store, use, and transport.

According to embodiments, this device uses a mechanical timer so that neither electrical outlets nor batteries are necessary.

The invention should be easy to manufacture by a company or individual skilled with manufacturing mechanical kitchen timers. All of the aforementioned parts all assembled and the timer mechanism functions as a mechanical timer would, as known to those skilled in the art.

While the method and apparatus have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation as to encompass all such modifications and similar structures. The present disclosure includes any and all embodiments of the following claims. It should also be understood that a variety of changes may be made without departing from the essence of the disclosure. Such changes are also implicitly included in the description. They fall within the scope of this disclosure. It should be understood, this disclosure is intended to yield a patent covering numerous aspects of the invention both independently and as an overall system, in both method and apparatus modes.

Further, each of the various elements of the disclosure and claims may also be achieved in a variety of manners. This disclosure should be understood to encompass each such variation, be it a variation of an implementation of any apparatus implementations, a method or process implementations, or merely a variation of any element of these.

Particularly, it should be understood that as the disclosure relates to elements of the invention, the words for each element may be expressed by equivalent apparatus terms or method terms—even if the function or result remains the same. Such equivalent, broader, or even more generic terms should be considered to be encompassed in the description of each element or action. Such terms can be substituted where desired, to make explicit, the implicitly broad coverage to which this invention is entitled.

It should be understood that all actions may be expressed as a means for taking that action or as an element which causes that action. Similarly, each physical element disclosed, should be understood, to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all references listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular exemplary implementations, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim which would have literally encompassed such alternative exemplary implementations.

Further, the use of the transitional phrase “comprising” is used to maintain the “open-end” claims herein, according to traditional claim interpretation. Thus, unless the context requires otherwise, it should be understood the term “compromise” or variations such as “comprises” or “comprising”, are intended to imply the inclusion of a stated element or step or group of elements or steps but not the exclusion of any other element or step or group of elements or steps. Such terms should be interpreted in their most expansive forms so as to afford the applicant the broadest coverage legally permissible.

What is claimed is:

1. A system for brewing tea, which comprises, in combination:
a cap assembly, including a hook/handle operative linked to a timing mechanism;
a tube having trapped air, for housing a piston which travels from a first position to a second position, based upon air pressure regulated by two duck-bill valves;
operatively linked to the timing mechanism by a bridge mechanism;
an ingress-egress means, likewise operatively linked to the timing mechanism;
a container; and,
a filter layer whereby, in use, the container houses loose leaf tea, which steeps in hot water for a duration of time pre-set by a user, that is meted-out by release of air pressure, as the piston moves from a first to a second position, rotating the bridge and ingress-egress means to allow for a finished product to be steeped for a time interval.

2. The system of claim 1, wherein the container is glass.

3. The system of claim 1, wherein the container is plastic.

4. The system of claim 2, wherein the overall size approximates that of a chicken egg.

5. The system of claim 4, wherein the filter layer is polypropylene.

6. The system of claim 5, whereby a sound is emitted when steeping is completed.

7. A multi-cap apparatus, which comprises, in combination:
a cap assembly;
a main container;
a timing mechanism; and,
a mesh layer wherein the timing mechanism is in operative communication with the cap assembly, and whereby a user can observe rotation of the timing mechanism to determine when the tea has been steeped appropriately.

8. The tea-steeping apparatus of claim 7, wherein multiple cups of tea are brewed owing to the volumes of water used.

9. A kit, comprising the system of claim 5, and instructions for use.

10. A kit, comprising the tea-steeping apparatus of claim 8, instructions for use, and a stand for drying and storage.

11. The tea-steeping apparatus of claim 8, further comprising a sound-emitting mechanism.

12. The tea-steeping apparatus of claim 11, further comprising an outer insulated vessel for transport.

13. A process for steeping and timing tea, which comprises, in combination:
supplying an integral vessel having a main cap assembly and an outer layer;
a timer mechanism operatively linked to a central bridge and a filter layer having apertures which align with holes in the outer layer to form ports;
filling the vessel with loose leaf tea and hot water;
rotating the timer mechanism to a desired setting; and,
allowing counter-rotation of said timer mechanism to align apertures from the filter layer with holes in said outer layer to close ports;
whereby tea is stepped only until the timer ends.

14. The process of claim 13, wherein the allowing step includes the step of timing the steeping step for a time period of 30 seconds to 10 minutes.

15. The method of claim 14, further comprising, housing the resultory tea in an insulated vessel for transport.
